(19) United States
(12) Patent Application Publication
(10) Pub. No.: US 2014/0202621 A1
(43) Pub. Date: Jul. 24, 2014

(54) MOLDING ROLLER, APPARATUS AND METHOD FOR MANUFACTURING SAME

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 13/954,059

(22) Filed: Jul. 30, 2013

(30) Foreign Application Priority Data
Jan. 24, 2013 (TW) 102102732

(51) Int. Cl. B29D 99/00

(52) U.S. Cl. CPC B29D 99/0032
USPC 156/187; 156/446

(57) ABSTRACT

A apparatus is used for manufacturing a molding roller, and includes a mixing assembly, a metallic plate, a curing device, a mounting device, and a cutting device. The mixing assembly obtains a molding film material by polymerization of polydimethylsiloxane and hard chain additive. The metallic plate has an imprinting surface with a number of imprinting patterns, and the molding film material is applied on the imprinting surface. The curing device cures the molding film material to obtain a molding film, the molding film has a molding surface in contact with the imprinting surface, and the molding surface has a number of molding patterns coupled with the imprinting patterns. The mounting device mounts the molding film to a circumferential surface of a main body, and the molding patterns is opposite to the main body. The cutting device cuts the molding film.

### BACKGROUND

1. Technical Field

The present disclosure relates to a molding roller, an apparatus and a method for manufacturing the molding roller.

2. Description of Related Art

Optical films include a number of micro structures. One method for forming the micro structures is a roll forming process using a metallic roller. The metallic roller has a circumferential surface including molding patterns for forming the micro structures. The molding pattern is formed by a laser knife. However, it is difficult to machine the molding patterns on a curved surface of the metallic roller, therefore, the machining efficiency is relatively low.

Therefore, it is desirable to provide a molding roller, an apparatus and a method for manufacturing the molding roller that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a molding roller, according to a first exemplary embodiment.

FIG. 2 is an apparatus for manufacturing a molding roller, according to a second exemplary embodiment.

FIG. 3 to FIG. 5 are flowcharts of a method for manufacturing a molding roller, according to a third exemplary embodiment.

### DETAILED DESCRIPTION

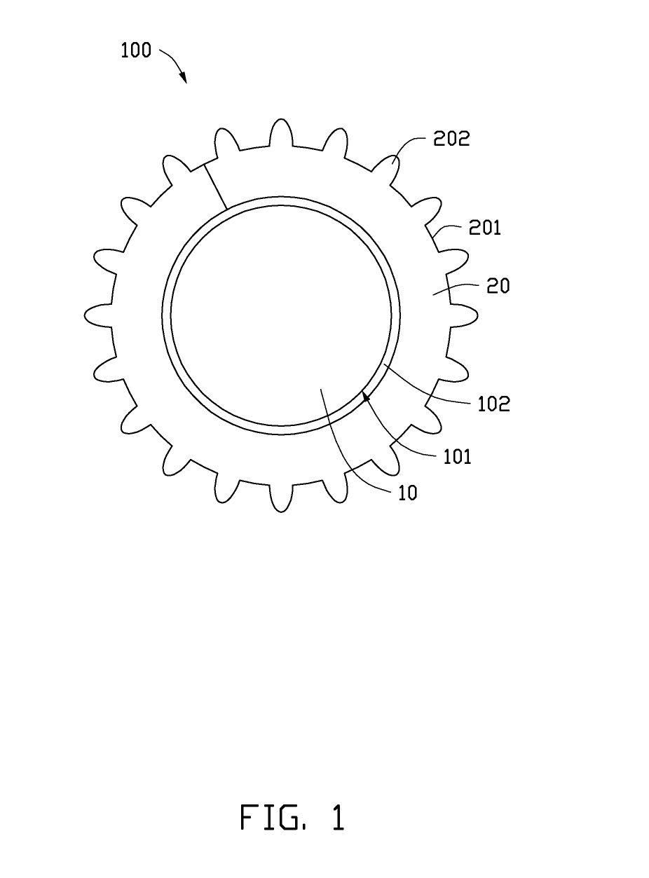

FIG. 1 illustrates a molding roller 100 in accordance to a first exemplary embodiment. The molding roller 100 includes a cylindrical main body 10 and a ring-shaped molding film 20. The main body 10 includes a circumferential surface 101, and can be made of stainless steel or other metals. The circumferential surface 101 is coated with an adhesive glue 102.

The molding film 20 is wound around and fixed to the smooth circumferential surface 101. The molding film 20 includes a molding surface 201 opposite to the main body 10. The molding surface 201 includes a number of molding patterns 202. In the first embodiment, the molding patterns 202 are micro striped protrusions. In other embodiments, the molding patterns 202 can be micro-dots or micro-grooves.

The molding film 20 is made of flexible polymer material. The flexible polymer material is obtained through polymerization of polydimethylsiloxane (PDMS) and hard chain additive. In the first embodiment, the hard chain additive is poly(siloxane-urethane) (PSiU) which is obtained through polymerization of 4,4′-diphenylmethane diisocyanate (MDI) and 1,4-butanediol (1,4-BD). Because the polymer material is easily separated from the optical films, the molding film 20 is easily separated from optical films, and the quality of the optical films can be greatly improved.

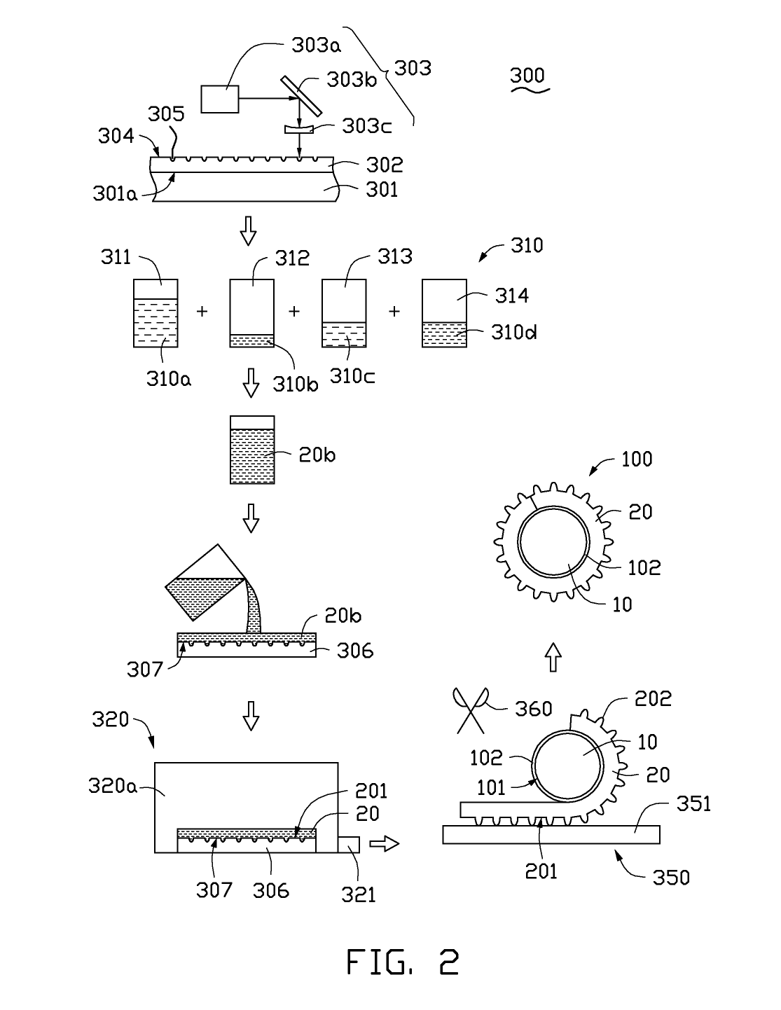

Referring to FIG. 2, an apparatus 300 for manufacturing the molding roller 100, according to a second exemplary embodiment, includes a planar loading plate 301, a preprocessed metal plate 302, a processing device 303, a mixing assembly 310, a curing device 320, a mounting device 350, and a cutting device 360.

The loading plate 301 has a planar loading surface 301a. The preprocessed metallic plate 302 is fixed to the loading surface 301a, and includes a preprocessed imprinting surface 304 opposite to the loading plate 301.

The processing device 303 is used for forming imprinting patterns 305 on the preprocessed imprinting surface 304 to obtain a metallic plate 306 and an imprinting surface 307. In the second embodiment, the processing device 303 includes a laser emitter 303a, a reflector 303b, and a converging lens 303c. The laser emitter 303a is used for emitting laser rays. The transmitting direction of the laser rays is substantially parallel to the preprocessed imprinting surface 304. The reflector 303b is used for changing the transmitting direction of the laser rays and reflecting the laser rays to the converging lens 303c. The converging lens 303c converges the laser rays to the preprocessed imprinting surface 304. In other embodiments, the reflector 303b and the converging lens 303c can be omitted, and the transmitting direction of the laser rays should be substantially perpendicular to the preprocessed imprinting surface 304. In other embodiments, if the imprinting patterns 305 are V-shaped grooves, and the processing device 303 can includes a diamond knife having a V-shaped blade.

The mixing assembly 310 is used for mixing the PDMS 310a and the hard chain additive 310b according the hardness requirement, and thus the PDMS 310a is polymerized with the hard chain additive 310b to obtain the molding film material 20b. The hard chain additive 310b is PSiU, and is obtained through the polymerization of MDI and 1,4-BD.

The mixing assembly 310 includes a first container 311, a second container 312, a third container 313, and a fourth container 314. The first container 311 receives the PDMS 310a. The second container 312 receives the hard chain additive 310b. The third container 313 receives a solvent 310c consisting of N,N-dimethylformamide (DMF) and tetrahydrofuran (THF). The fourth container 314 receives a catalyst 310d. In the second embodiment, the catalyst 310d is di-n-butyltin dilaurate (T-12), and the weight of the catalyst 310d is 0.02% of the sum of the weight of the PDMS 310a and the weight of the hard chain additive 310b.

In particular, the PDMS 310a and the hard chain additive 310b are mixed according the hardness requirement to obtain a mixed solute, the mixed solute is poured into the solvent 310c, the mixed solute and the solvent are stirred at a predetermined temperature (such as 55° C.) for a predetermined period (such as 2 hours), and thus the mixed solute is absolutely dissolved in the solvent 310c to obtain a reaction liquid. Then the catalyst 310d is added into the reaction liquid, and the catalyst 310d promotes the polymerization of the PDMS 310a and the hard chain additive 310b, and thus the molding film material 20b is obtained. In the second embodiment, the first container 311, the second container 312, the third container 313, and the fourth container 314 are measuring glasses.

The molding film material 20b is poured on the imprinting surface 307 of the metallic plate 306. The curing device 320 is used for curing the molding film material 20b to obtain a molding film 20 and a molding surface 201. In the second embodiment, the curing device 320 includes a vacuum chamber 320a having a vent 321. The air in the vacuum chamber 320a can be drawn out through the vent 321, and thus a number of air bubbles in the molding film material 20b can be removed. When the temperature of the vacuum chamber 320a is gradually increased, the molding film material 20b can be cured to obtain the molding film 20. The molding surface 201 is coupled with the imprinting surface 307, and thus the molding surface 201 has a number of molding patterns 202 coupled with the imprinting patterns 305. In the second embodiment, the molding patterns 202 are micro striped protrusions.

The mounting device 350 is used for mounting the molding film 20 on the circumferential surface 101 of the main body 10, and includes a working platform 351. The molding film 20 is positioned on the working platform 351, and the molding patterns 202 are in contact with the working platform 351. The circumferential surface 101 is coated with the adhesive glue 102, and the main body 10 presses an end of the molding film 20, then the main body 10 is rolled on the molding film 20 to make the molding film 20 wound around the circumferential surface 101 of the main body 10.

The cutting device 360 is used for cutting the molding film 20. The molding film 20 and the main body 10 corporate to form the molding roller 100.

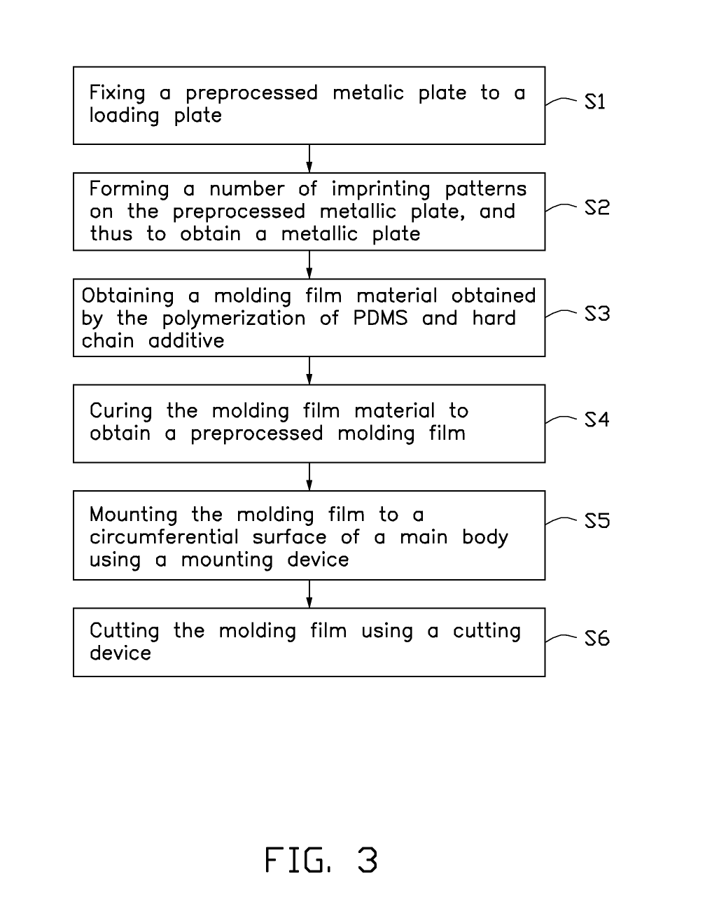

FIG. 3 illustrates a method for manufacturing the molding roller 100 using the apparatus 300 according to a third exemplary embodiment. The method includes the following steps.

In step S1, the preprocessed metallic plate 302 is provided and fixed to the planar loading surface 301a of the loading plate 301. The processed metallic plate 302 has a planar preprocessed imprinting surface 304 opposite to the loading plate 301.

In step S2, the imprinting patterns 305 are formed on the planar preprocessed imprinting surface 304 using the processing device 303, and thus the metallic plate 306 and the imprinting surface 307 are obtained. In the third embodiment, the processing device 303 emits laser rays to process the metallic plate 302.

In step S3, the PDMS 310a and the hard chain additive 310b are mixed using the mixing assembly 300 according to the hardness requirement, then the PDMS 310a is polymerized with the hard chain additive 310b to obtain the molding film material 20b.

In step S4, the molding film material 20b is uniformly poured on the imprinting surface 307 of the metallic plate 306, and the metallic plate 306 with the molding film material 20b is received in the curing device 320, the air of the curing device 320 is drawn out, and thus the air bubbles in the molding film material 20b are removed, and then the curing device 320 cures the molding film material 20b, and the molding film 20 is obtained. The molding film 20 has the molding surface 201 in contact with the imprinting surface 307. The molding surface 201 has a number of molding patterns 202 coupled with the imprinting patterns 305.

In step S5, the molding film 20 is wound around and fixed to the circumferential surface 101 of the main body 10 using the mounting device 350, and the molding surface 201 is opposite to the circumferential surface 101.

In step S6, the cutting device 360 cuts the molding film 20.

In other embodiments, the order of the step S5 and the step S6 also can be interchanged.

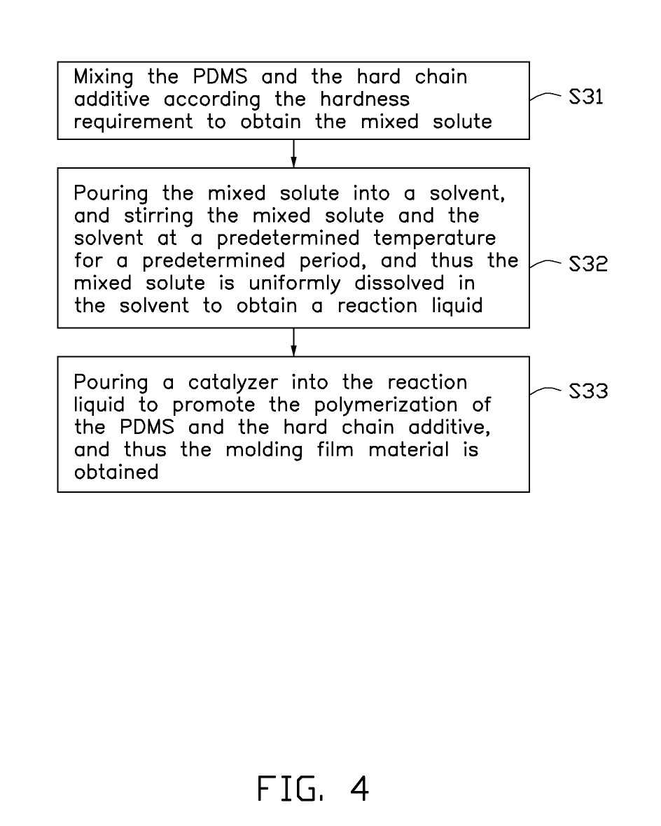

Referring to FIG. 4, the step S3 further includes the following sub-steps.

In step S31, the PDMS 310a and the hard chain additive 310b are mixed according the hardness requirement to obtain the mixed solute. In the third embodiment, the hard chain additive 310b is PSiU obtained through the polymerization of MDI and 1,4-BD.

In step S32, the mixed solute is poured into the solvent 310c consisting of DMF and THF, then the mixed solute and the solvent 310 are stirred at the predetermined temperature (such as 55° C.) for the predetermined period (such as 2 hours), and thus the mixed solute is uniformly dissolved in the solvent 310c to obtain a reaction liquid.

In step S33, the catalyst (such as T-12) 310d is poured into the reaction liquid to promote the polymerization of the PDMS 310a and the hard chain additive 310b, and thus the molding film material 20b is obtained.

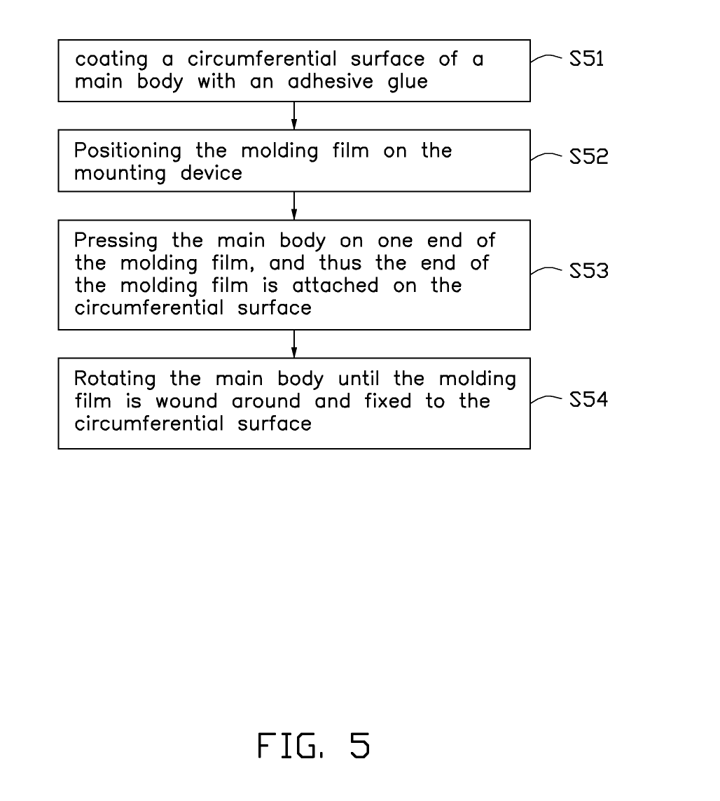

FIG. 5 illustrates that the step S5 further includes the following sub-steps.

In step S51, the circumferential surface 101 is coated with the adhesive glue 102.

In step S52, the molding film 20 is positioned on the mounting device 350, and the molding surface 201 is opposite to the main body 10.

In step S53, the main body 10 presses an end of the molding film 20, and thus the end of the molding film 20 is attached on the circumferential surface 101.

In step S54, the main body 10 is rotated until the molding film 20 is wound around and fixed to the rolling surface 101.

By employing the apparatus 300 and the above described method, it is easier for the processing device 303 to machine the imprinting patterns 305 on the planar preprocessed imprinting surface 304 relative to a curved surface. Therefore, the machining efficiency is improved.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An apparatus for manufacturing a molding roller, comprising:
a mixing assembly configured for obtain a molding film material by polymerization of polydimethylsiloxane and hard chain additive;
a metallic plate having an imprinting surface with a plurality of imprinting patterns, and the molding film material being applied on the imprinting surface;
a curing device configured for curing the molding film material to obtain a molding film, the molding film having a molding surface in contact with the imprinting surface, and the molding surface having a plurality of molding patterns coupled with the imprinting patterns;
a mounting device configured for mounting the molding film to a circumferential surface of a main body, wherein the molding patterns is opposite to the main body; and
a cutting device for cutting the molding film.

2. The apparatus of claim 1, wherein the mixing assembly comprises a first container, a second container, a third container, and a fourth container, the first container receives the polydimethylsiloxane, the second container receives the hard chain additive, the third container receives a solvent, the fourth container receives a catalyst.

3. The apparatus of claim 2, wherein the hard chain additive is poly(siloxane-urethane) obtained through the polymerization of 4, 4′-diphenylmethane diisocyanate and 1,4-butanediol.

4. The apparatus of claim 3, wherein the solvent is consisted of N,N-dimethylformamide and tetrahydrofuran, the catalyst is di-n-butyltin dilaurate

5. The apparatus of claim 4, wherein the weight of the catalyst is 0.02% of the sum of the weight of the polydimethylsiloxane and the weight of the hard chain additive.

6. The apparatus of claim 1, wherein the processing device comprises a laser emitter, a reflector, and a converging lens, the laser emitter emits laser rays, the transmitting direction of the laser rays is substantially parallel to the preprocessed imprinting surface, the reflector changes the transmitting direction of the laser rays and reflecting the laser rays to the converging lens, the converging lens converges the laser rays to the preprocessed imprinting surface.

7. The apparatus of claim 1, wherein the curing device comprises a vacuum chamber having a vent, the metallic plate with the molding film material is received in the vacuum chamber.

8. The apparatus of claim 1, further comprising a processing device and a loading plate, wherein the processing device is configured for forming a plurality of imprinting patterns on a preprocessed metallic plate to obtain the metallic plate, the loading plate is configured for fixing the preprocessed metallic plate, the preprocessed metallic plate has a preprocessed imprinting surface opposite to the loading plate.

9. The apparatus of claim 1, wherein the mounting device comprises a working platform, the preprocessed molding film is positioned on the working platform, and the molding patterns are in contact with the working platform, the circumferential surface is coated with an adhesive glue, and the main body is configured to press an end of the preprocessed molding film, and wind up the preprocessed molding film around the circumferential surface of the main body

10. A method for manufacturing a molding roller, comprising:
obtaining a molding film material obtained by polymerization of polydimethylsiloxane and hard chain additive;
applying the molding film material on a metallic plate with a plurality of imprinting patterns, and curing the polymer resin on the metallic plate using a curing device, and thus to obtain a molding film having a molding surface in contact with the imprinting surface, wherein the molding surface has a plurality of molding patterns coupled with the imprinting patterns;
mounting the molding film to a circumferential surface of a main body using a mounting device; and
cutting the molding film using a cutting device.

11. The method of claim 10, wherein the step obtaining a molding film material by the polymerization of polydimethylsiloxane and hard chain additive of further comprises:
mixing the PDMS and the hard chain additive according the hardness requirement to obtain the mixed solute;
pouring the mixed solute into a solvent, and stirring the mixed solute and the solvent at a predetermined temperature for a predetermined period, and thus the mixed solute is uniformly dissolved in the solvent to obtain a reaction liquid; and
pouring a catalyst into the reaction liquid to promote the polymerization of the PDMS and the hard chain additive, and thus the molding film material is obtained.

12. The method of claim 10, wherein the step of curing the molding film material on the metallic plate using a curing device further comprises:
placing the metallic plate on the polymer resin in a vacuum chamber;
drawing out the air in the vacuum chamber; and
gradually increasing the temperature of the vacuum chamber until the polymer resin is solidified.

13. The method of claim 10, wherein the step of mounting the molding film to a circumferential surface of a main body using a mounting device further comprises:
coating the circumferential surface with an adhesive glue;
positioning the molding film on the mounting device, wherein the molding surface is opposite to the main body;
pressing the main body on one end of the molding film, and thus the end of the molding film is attached on the circumferential surface; and
rotating the main body until the molding film is wound around and fixed to the rolling surface.
